(19) United States
(12) Patent Application Publication
(10) Pub. No.: US 2026/0330819 A1
(43) Pub. Date: Oct. 22, 2026

(54) TRAINING OBJECT DETECTION NEURAL NETWORKS

(71) Applicants: University of Surrey, Guilford (GB); JM Radiology Limited, Hailsham (GB)

(72) Inventors: Yunpeng Li, Guilford (GB); Jonathan Tan, Sutton (GB)

(21) Appl. No.: 19/105,665

(22) PCT Filed: Aug. 22, 2023
(86) PCT No.: PCT/GB2023/052192

§ 371 Date: Feb. 21, 2025

(30) Foreign Application Priority Data
Aug. 24, 2022 (GB) 2212322.8

(51) Int. Cl. G06V 10/82; G06T 7/00; G06V 10/25; G06V 10/764; G06V 10/778

(52) U.S. Cl. CPC G06V 10/82; G06T 7/0012; G06V 10/25; G06V 10/764; G06V 10/7796; G06T 2207/20081; G06T 2207/30036; G06V 2201/03

(57) ABSTRACT

This specification provides a method implemented by one or more processors for training an object detection neural network comprising a plurality of parameters. The method comprises receiving one or more training examples of a current training iteration. Each training example comprises an image and one or more training labels. Each training label is derived from a respective source from a set of sources. Each training label comprises object information for each of one or more objects in the image. The object information comprises a representation of: (i) a location of the object in the image, and (ii) a class for the object represented by the object information, the class being a class from a set of object classes. The method comprises determining a training loss for each of the training examples, and updating the parameters of the object detection neural network based on the training loss of one or more training examples.

### FIELD OF THE INVENTION

This specification relates to the training of object detection neural networks.

### BACKGROUND

Neural networks can be trained to perform object detection on images, however it may be difficult to obtain accurate training labels for object detection tasks. Training object detection neural networks with inaccurate training labels may degrade their performance.

### SUMMARY

In accordance with a first aspect, this specification provides a method implemented by one or more processors for training an object detection neural network comprising a plurality of parameters. The method comprises receiving one or more training examples of a current training iteration. Each training example comprises an image and one or more training labels. Each training label is derived from a respective source from a set of sources. Each training label comprises object information for each of one or more objects in the image. The object information comprises a representation of: (i) a location of the object in the image, and (ii) a class for the object represented by the object information, the class being a class from a set of object classes. For each of the one or more training examples for the current training iteration, the method comprises generating an output for the training example, comprising processing the image of the training example using the object detection neural network. The output comprises predicted object information for each of one or more predicted objects in the image, each predicted object information comprising a representation of: (i) a predicted location of the predicted object in the image, and (ii) a predicted probability distribution over the set of object classes. The method comprises determining a training loss for the training example, comprising: determining, for each of the one or more predicted objects, an inferred training label comprising a representation of: (i) an inferred location of the predicted object, and (ii) an inferred probability distribution over the set of object classes for the predicted object, the inferred probability distribution being determined based on a posterior approximating distribution over the set of object classes, wherein the posterior approximating distribution is determined using the predicted probability distribution and a Dirichlet distribution as a prior distribution. Determining the training loss for the training example further comprises determining, for each of the one or more predicted objects, a classification loss in dependence on the predicted probability distribution and the inferred probability distribution for the predicted object, and a location loss in dependence on the predicted location and the inferred location of the predicted object; and determining the training loss for the training example, the training loss comprising a combination of the one or more classification losses and the one or more location losses. The method further comprises updating the parameters of the object detection neural network based on the training loss of one or more training examples.

In accordance with a second aspect, this specification provides a computing system configured to perform the method of the first aspect.

In accordance with a third aspect, this specification provides a non-transitory computer-readable medium containing instructions, which when executed by one or more processors, cause the one or more processors to perform the method of the first aspect.

### BRIEF DESCRIPTION OF THE DRAWINGS

Embodiments of the present invention will now be described, by way of example only, with reference to the accompanying drawings, in which:

FIG. 1 illustrates an example method of performing object detection with a neural network;

FIG. 2 illustrates example bitewing radiograph annotated with dental diseases;

FIG. 3 illustrates an example method of training an object detection neural network with inferred training labels;

FIG. 4 is a flowchart illustrating an example method for training an object detection neural network; and

FIG. 5 shows a schematic example of a system/apparatus for performing any of the methods described herein.

### DETAILED DESCRIPTION

Example implementations provide systems and methods for training an object detection neural network. In particular, the systems and methods described herein enable the training of object detection neural networks with training data obtained from multiple sources (e.g. multiple annotators, each of varying annotation quality). This is particularly useful for specialised domains, such as the medical domain, where it is difficult to obtain a sufficient amount of training data from expert annotators (e.g. medical professionals). Instead of requiring all (or a substantial portion) of the training data to be obtained from expert annotators, methods and systems described herein enable training of object detection neural networks using training data that is obtained from a wider range of sources (e.g. crowdsourced annotations), while achieving an acceptable level of performance in the object detection task despite uncertainty in the reliability of the training labels. As a particular example, the object detection neural network can be trained to perform object detection in a specialised domain without requiring any training data obtained from expert annotators. Furthermore, the systems and methods described herein may be applied to a wide variety of object detector neural networks without requiring modification (or minimal modification) of the object detector neural network.

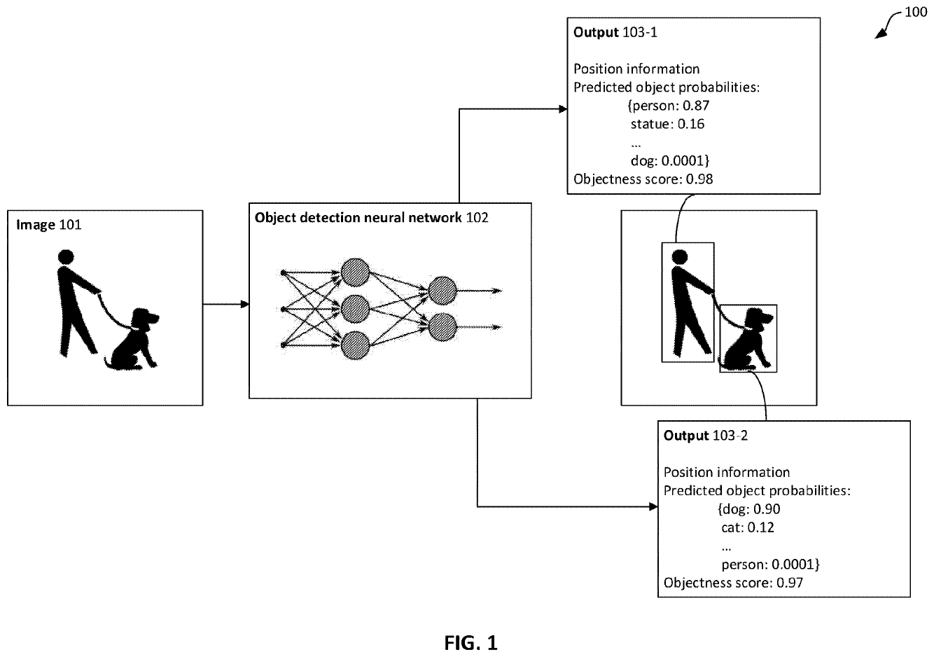

FIG. 1 illustrates an example method 100 of performing object detection with a neural network 102.

The object detection neural network 102 receives an image 101 as input. The image 101 may be any image containing objects for which the object detection neural network 102 has been trained to detect. For example, the image 101 may be a general image captured “in the wild”, containing everyday objects. Additionally or alternatively, the image 101 may belong to a specialised domain, such as a medical domain. For example, the image 101 may be a radiograph such as a dental radiograph (e.g. a bitewing radiograph).

The image 101 may be an image comprising a plurality of channels, e.g. an RGB image. Additionally or alternatively, the image 101 may be a grayscale image comprising a single channel of brightness values. The image 101 comprises a plurality of pixel values and has a height and width. The image 101 may be pre-processed prior to input to the object detection neural network 102. For example, the image 101 may be cropped and/or resized to have a particular height and/or width. As another example, if the image 101 is an RGB image, it may be first converted into a grayscale image. Any suitable pre-processing operation may be performed to the image 101 prior to input to the object detection neural network 102.

The object detection neural network 102 is a neural network that has been trained to perform object detection. The object detection neural network 102 may have been trained using general images captured “in the wild”, and trained to detect everyday objects. Additionally or alternatively, the object detection neural network 102 may have been trained using images belonging to specialised domains such as a medical domain.

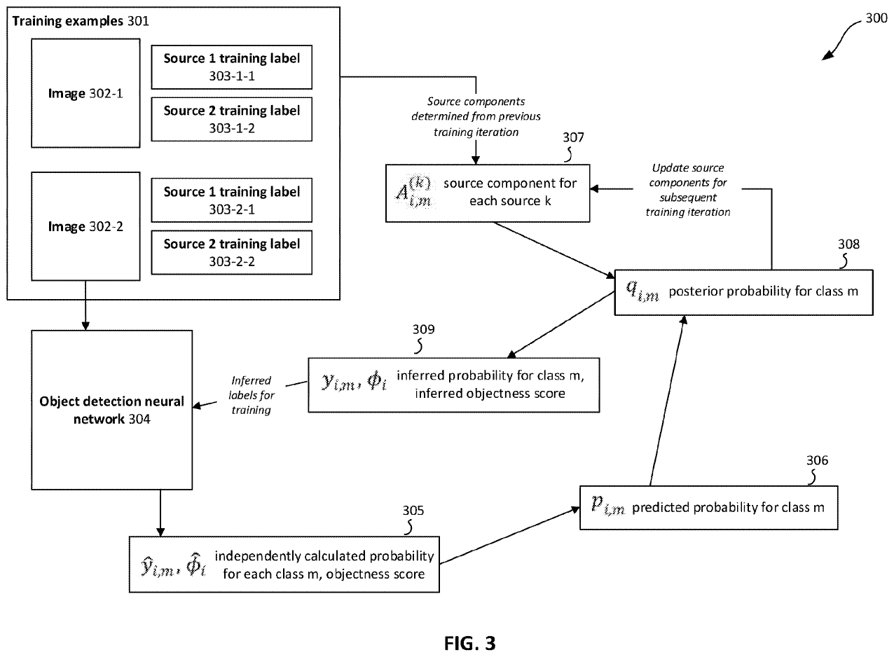

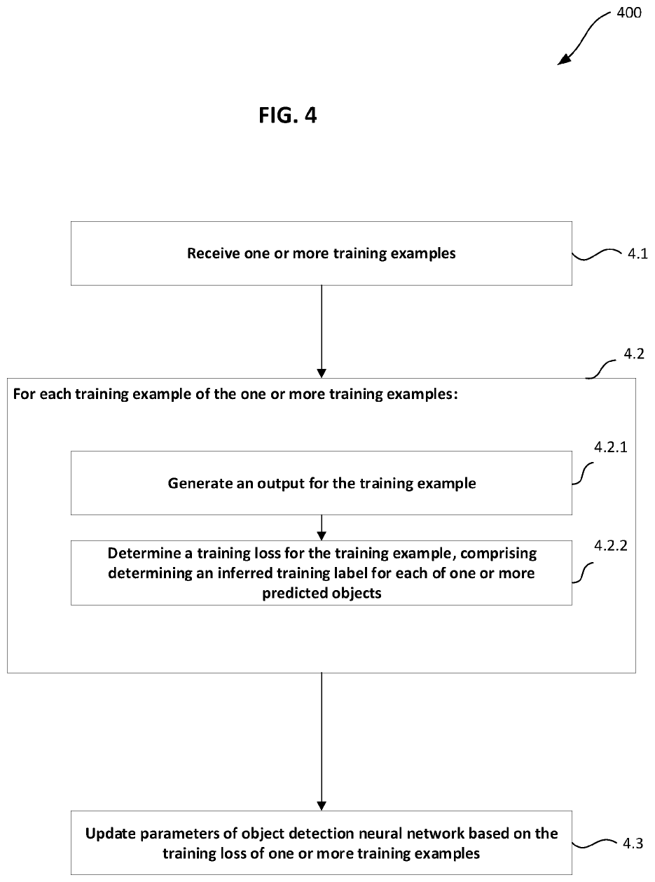

The object detection neural network 102 comprises a plurality of neural network layers, each neural network layer associated with one or more parameters. The parameters of the object detection neural network 102 are learned after performing a training process with training examples, as will be described in further detail in relation to FIGS. 3 and 4.

The plurality of neural network layers may comprise any suitable neural network layer. For example, the object detection neural network 102 may comprise one or more convolutional layers, one or more linear projection layers, one or more max-pooling layers, one or more batch normalization layers, one or more upsampling layers etc. The object detection neural network 102 may comprise one or more residual connections between neural network layers. Where the object detection neural network 102 comprises one or more convolutional layers, the one or more convolutional layers may be configured to operate on representations of the image 101 at differing spatial resolutions/dimensions. For example, one or more convolutional layers may process a representation of the image 101 that has a first height and width, and one or more other convolutional layers may process a representation of the image that has a second height and width.

The object detection neural network 102 may comprise various portions. For example, the object detection neural network 102 may comprise a feature extractor portion which generates feature representations for the input image 101. The feature extractor portion may generate feature representations of different spatial resolutions/dimensions. The object detection neural network 102 may comprise one or more output portions. Each output portion is configured to generate an output 103 from processing the input image 101. Different output portions may generate outputs for different spatial resolutions/dimensions of the input image. For example, a first output portion may generate an output 103 for a representation of the image having a first height and width, and a second output portion may generate an output 103 for a representation of the image having a second height and width.

In some implementations, the object detection neural network 102 is a one-stage object detector. A one-stage object detector receives an input image 101 and performs object detection for the entire input image 101 simultaneously. On the other hand, two-stage object detectors generally include a region proposal portion that processes the image 101 and generates proposed regions of the input image 101 for which there may be objects, and performs object detection on the proposed regions separately. One-stage object detectors may be preferable as generally, object detection outputs can be obtained more quickly than in two-stage object detectors.

The object detection neural network 102 generates an output 103 for each predicted object in the image 101. As shown in the example of FIG. 1, two objects are portrayed in the input image 101. Output 103-1 is generated for the first predicted object, and output 103-2 is generated for the second predicted object. Each output 103 comprises object information for the predicted object. The output 103 comprises a representation of position information for the predicted object, predicted object probabilities, and an objectness score.

The representation of position information is any information that can be used to represent the position of the object with respect to the input image 101. For example, the output 103 may comprise a representation of position information in the form of absolute co-ordinates, e.g. with respect to the top-left corner of the image as an origin point. Absolute co-ordinates may be generated for each corner of a predicted bounding box for the input image 101 that displays the predicted object.

Alternatively, the representation of position information may be in the form of relative co-ordinates, or offsets, and relative scales. In this example, the object detection neural network 102 may be trained to generate an output 103 for each of one or more anchor boxes. For example, the input image 101 may be divided into a grid of equally sized cells, and one or more anchor boxes may be provided for each cell. The width and height of the anchor boxes may be pre-determined, and the position information specified in an output 103 may be used to adjust the size and location of the pre-determined anchor box to generate a bounding box.

For example, the position information of an output 103 for an anchor box may be used to determine the centre of the bounding box by specifying an offset (or relative co-ordinates) with respect to the top-left corner of the cell for the bounding box. The offset co-ordinates may be constrained to be between 0 and 1 (e.g. for both the x-axis offset and γ-axis offset of the offset co-ordinates), e.g. by applying a sigmoid function to an intermediate offset output. Absolute co-ordinates for the centre of the bounding box may be determined by adding together the offset co-ordinates with the co-ordinates of the top-left corner of the cell.

The position information of the output 103 for the anchor box may also be used to determine the width and height of the bounding box by specifying scale parameter(s) to adjust the pre-determined width and height of the anchor box. For example, the pre-determined width may be multiplied by a width scale parameter specified by the position information for the output 103. Similarly, the pre-determined height may be multiplied by a height scale parameter specified by the position information for the output 103. Scale parameters may be constrained to be positive numbers, e.g. applying an exponential function to an intermediate scale output.

The output 103 comprises predicted object probabilities for an area/portion of the image 101 represented by the positional information for the output 103. A predicted object probability is determined for each object in a set of object classes. As can be seen in the example of FIG. 1, output 103-1 indicates a high probability that the portion of the image specified by the position information portrays a person, a low probability that the portion portrays a statue, and a near zero probability that the portion portrays a dog. Output 103-2 indicates a high probability that the portion of the image specified by the position information portrays a dog.

The object detection neural network 102 may be configured to calculate the probability for each object in the set of object classes independently of each other. In other words, the predicted object probabilities of an output 103 might not be over the set of object classes, and thus might not require the probabilities to sum to 1 as can be seen in the example outputs 103 of FIG. 1. This may be achieved through the inclusion of a separate binary classifier for each class in the set of object classes. This may be helpful in certain use cases where objects in different classes overlap in the same area of the image 101. A binary classifier may be implemented using a sigmoid function, for each class in the set of object classes, applied to an input of the sigmoid function. The input to the sigmoid function may be the same for each of the classes, and may be obtained from output of a previous neural network layer of the object detection neural network 102.

As shown in FIG. 1, each output 103 comprises an objectness score. The objectness score represents the probability that any object in the set of object classes is present in the area/portion of the image 101 represented by the position information for the output 103. It will be appreciated that in some implementations, the objectness score may be determined by including a background class in the set of object classes, wherein the predicted probability for the background class represents the probability that no object of the other classes in the set (e.g. excluding the background class) is portrayed in the portion of the image 101.

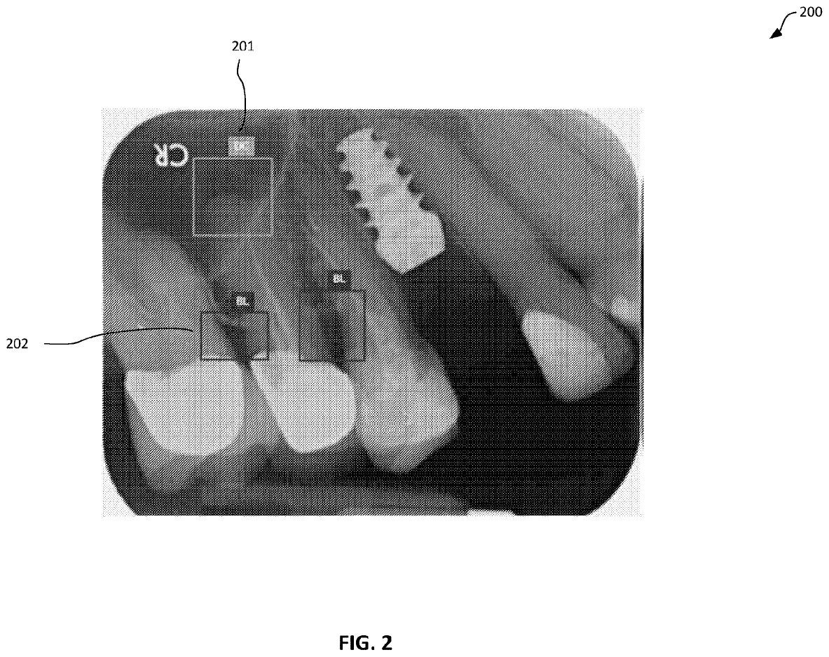

FIG. 2 illustrates an example bitewing radiograph 200 annotated with dental diseases. In this example, the set of object classes correspond to dental disease types. In particular, the set of object classes includes dental caries (tooth decay) and bone loss. The region 201 of the bitewing radiograph 200 portrays dental caries, and region 202 of the bitewing radiograph 200 portrays bone loss.

An object detection neural network may be trained to process bitewing radiographs 200 to identify regions 201, 202 of the radiograph portraying dental diseases and to classify the dental disease type portrayed in the image.

Obtaining training data for training an object detection neural network to perform dental disease detection is difficult, as generally, a substantial number of training examples are required to achieve an acceptable level of performance (e.g. accurately identifying areas where bone loss and dental caries have occurred). Furthermore, it may be difficult to obtain a sufficient number of accurately annotated bitewing radiographs.

The methods and systems described in relation to FIGS. 3 and 4 can be used to train an object detection neural network to perform dental disease detection using training examples obtained from a variety of sources. For example, the training examples can be obtained from crowdsourced annotators. Although the annotation quality of individual annotators may be lower than annotations provided by expert annotators (e.g. dentists), the methods and systems described herein enable more accurate training labels to be inferred based on crowdsourced annotations (e.g. those provided by non-experts). Thus, object detection neural networks can be trained to perform dental disease detection with an acceptable level of performance, by using the inferred training labels to replace training labels obtained from crowdsourcing and training the object detection neural network using the inferred training labels.

It will be appreciated that dental disease detection is a particular example of the implementations described herein, and that the methods and systems described in relation to FIGS. 3 and 4 can be used to perform accurate detection of other diseases, and more generally, any object using training examples derived from crowdsourced annotations.

FIG. 3 illustrates an example method 300 of training an object detection neural network 304 with inferred training labels 309 derived from one or more training examples 301.

The training examples 301 include a plurality of images 302-1, 302-2 and corresponding training labels 303 for each image 302. For ease of illustration, only two training examples are illustrated in FIG. 3 but it will be appreciated that any number of training examples may be provided.

Each image 302 is associated with one or more training labels 303, each training label being obtained or derived from a particular source of a set of sources. In the example of FIG. 3, two sources for the training labels 303 are shown that each provide a training label for images 302-1, 302-2. However, it will be appreciated that any number of sources may provide training labels 303, and that the number of sources/training labels may differ for different images 302.

The image 302 may be any image containing objects for which the object detection neural network 304 is being trained to detect. For example, the image 302 may be a general image captured “in the wild”, containing everyday objects. Additionally or alternatively, the image 302 may belong to a specialised domain, such as a medical domain. For example, the image 302 may be a radiograph such as a dental radiograph (e.g. a bitewing radiograph).

The image 302 may be an image comprising a plurality of channels, e.g. an RGB image. Additionally or alternatively, the image 302 may be a grayscale image comprising a single channel of brightness values. The image 302 comprises a plurality of pixel values and has a height and width. The image 302 may be pre-processed prior to input to the object detection neural network 304. For example, the image 101 may be cropped and/or resized to have a particular height and/or width. As another example, if the image 101 is an RGB image, it may be first converted into a grayscale image. Any suitable pre-processing operation may be performed to the image 101 prior to input to the object detection neural network 304.

A first source provides training label 303-1-1 for image 302-1 and training label 303-2-1 for image 302-2. A second source provides training label 303-1-2 for image 302-1 and training label 302-2-2 for image 302-2.

Each training label 303 comprises object information for each of one or more objects in the image 302. The object information comprises a representation of: (i) a location of the object in the image 302, and (ii) a class for the object represented by the object information, the class being a class from a set of object classes. The set of object classes may include a background class.

The representation of the location of the object in the image 302 may be provided in any suitable manner. For example, the location may be represented by position information used to represent the position of the object with respect to the input image 302. For example, the representation of the location may comprise a representation of position information in the form of absolute co-ordinates, e.g. with respect to the top-left corner of the image as an origin point. Absolute co-ordinates may be provided for each corner of a bounding box for the image 302 that portrays the object.

Alternatively, the location may be represented by position information in the form of relative co-ordinates, or offsets, and relative scales. In this example, the object detection neural network 304 may be being trained to generate an output for each of one or more anchor boxes. For example, the input image 302 may be divided into a grid of equally sized cells, and one or more anchor boxes may be provided for each cell. The width and height of the anchor boxes may be pre-determined, and the position information specified in the training label 303 may be used to adjust the size and location of the pre-determined anchor box to determine a bounding box for the object.

For example, the position information of a training label 303 for an anchor box may specify an offset (or relative co-ordinates) with respect to the top-left corner of the cell for the bounding box. The offset may define the centre of the bounding box, for example the centre of the bounding box may be defined by adding together the offset co-ordinates with the co-ordinates of the top-left corner of the cell. The offset co-ordinates may be constrained to be between 0 and 1 (e.g. for both the x-axis offset and y-axis offset of the offset co-ordinates).

The position information of the training label 303 for the anchor box may also be used to define the width and height of the bounding box by specifying scale parameter(s) to adjust the pre-determined width and height of the anchor box. For example, the pre-determined width may be multiplied by a width scale parameter specified by the position information for the training label 303. Similarly, the pre-determined height may be multiplied by a height scale parameter specified by the position information for the training label 303. Scale parameters may be constrained to be positive numbers.

The class for the object represented by the object information of a training label 303 may be provided in the form of a vector indicating a particular class for the object. For example, a one-hot vector may be used to indicate a particular class, with each element of the vector being associated with a particular class of the set of object classes.

The object information for each object may be provided in the form of a vector, and the training label 303 may comprise a collection of the vectors corresponding to the objects for the image 302.

The method 300 shows the processing the image 302-2 of a single training example during a current training iteration, however it will be appreciated that any number of training examples may be used during the current training iteration. For example, all of the training examples 301 (or a subset thereof) may be simultaneously processed in the method 300.

Object detection neural network 304 processes image 302-2 and outputs 305 a probability, independently calculated for each class in the set of object classes, and an objectness score. The probability for class m∈{1, . . . . M} is denoted as ŷ_{i,m} and the objectness score is denoted by \hat{φ}ᵢ, where the index i indexes a particular object that has been detected by the object detection neural network 304. As explained previously, it will be appreciated that in some implementations, the objectness score might not be a separate output for the predicted object, but may be determined from an output representing the probability for a background class included in the set of object classes.

Although not illustrated, the object detection neural network 304 also outputs a representation of a predicted location for the object. The predicted location may be represented by position information. As described previously, the position information may be in the form of absolute co-ordinates. Alternatively, the position information may be in the form of relative co-ordinates, which may be represented by offset co-ordinates (or parameters representative thereof) and scale parameters for each of one or more bounding boxes. In this example, the index i may index a particular bounding box predicted for the image 302-2.

The method 300 determines 306 a predicted probability for each class in the set of object classes using the independently calculated probabilities and objectness score. The predicted probabilities define a probability distribution over the set of object classes, wherein the set of object classes includes a background class. The predicted probability for class m∈{0, 1, . . . , M} is denoted as p_{i,m}, where p_{i,0} represents the predicted probability for the background class. By defining a probability distribution over the set of object classes, the predicted probabilities may satisfy the condition that

$${\sum }_{{m}^{′} = 0}^{M} {p}_{i , {m}^{′}} = 1.$$

This may be achieved in any suitable manner, e.g. by using the independently calculated probabilities and the objectness score. In one particular implementation, the predicted probability for the background class is calculated as: p_{i,0}=1−\hat{φ}ᵢ. In this implementation, the predicted probability for class m∈{1, . . . , M} may be calculated as:

$${p}_{i , m} = \frac{{\hat{ϕ}}_{i} {\hat{y}}_{i , m}}{{\sum }_{{m}^{′} = 1}^{M} {\hat{y}}_{i , {m}^{′}}}$$

As described previously, in some implementations the object detection neural network 304 generates an output representing the probability for a background class included in the set of object classes, e.g. as part of the independently calculated probabilities. In these implementations, the object detection neural network 304 may omit generating an objectness score, and the predicted probability for class m∈{0, 1, . . . , M} may be set as the independently calculated probability for the class. For example, p_{i,m}=ŷ_{i,m} for all m∈{0, 1, . . . , M}.

The method 300 obtains 307 source components determined from a previous training iteration for use in calculating a posterior probability for each class m € {0, . . . , M}. Each source component is dependent on a particular class and a particular source, and is denoted as

$${A}_{i , m}^{( k )} ,$$

where the index k∈{1, . . . , K} indexes a particular source of the one or more sources.

The method 300 determines 308 a posterior probability for each class m∈{0, . . . , M} using the source components

$${A}_{i , m}^{( k )}$$

for each source k∈{1, . . . , K} and each class m∈{0, . . . , M}, and the predicted probability p_{i,m} of each class m∈{0, . . . , M}. The posterior probability for class m is denoted as q_{i,m}. The posterior probabilities may define a posterior approximating distribution over the set of object classes, satisfying the condition that

$${\sum }_{{m}^{′} = 0}^{M} {q}_{i , {m}^{′}} = 1.$$

A weighted predicted probability may first be determined for each predicted probability p_{i,m} by determining a weight for weighting the predicted probability. For example, the weight may be calculated first by summing the source components

$${A}_{i , m}^{( k )} ,$$

and then applying an exponent to the summed source components. The posterior probability q_{i,m} for each class m may be determined by dividing the weighted predicted probability for class m by a sum of the weighted predicted probabilities. For example, the posterior predicted probability for class m may be calculated as:

$${q}_{i , m} = \frac{exp ( {\sum }_{{k}^{′} = 1}^{K} {A}_{i , m}^{( {k}^{′} )} ) {p}_{i , m}}{{\sum }_{{m}^{′} = 0}^{M} exp ( {\sum }_{{k}^{′} = 1}^{K} {A}_{i , {m}^{′}}^{( {k}^{′} )} ) {p}_{i , {m}^{′}}}$$

Subsequent to determining the posterior probabilities, the source components

$${A}_{i , m}^{( k )}$$

are updated for each source k∈{1, . . . , K} and each class m∈{0, . . . , M}. The source components are updated for use in determining a posterior approximating distribution for a subsequent training iteration, using the current posterior probabilities q_{i,m}, a prior Dirichlet distribution over the set of object classes associated with source k, and the training examples 301.

For example, the source components

$${A}_{i , m}^{( k )}$$

may be updated using the following equations:

$${A}_{i , m}^{k )} = ψ ( {\tilde{α}}_{m , {c}_{i}^{( k )}} ) - ψ ( {\sum }_{{η}^{′} = 0}^{H} {\tilde{α}}_{m , {η}^{′}} )$$

$${\tilde{α}}_{m , η} = {α}_{0 m , η}^{( k )} + {\sum }_{i} 𝕀 [ {c}_{i}^{( k )} = η ] {q}_{i , m}$$

In the above equations, ψ represents the digamma function, and the training label 303 provided by source k indicate a particular class for object i (or, if appropriate, bounding box i) denoted by

$${c}_{i}^{( k )} = η ∈ \{ 0 , … H \} ,$$

where O may represent a background class. In some implementations, the number of classes annotated by source k is equal to the number of classes in the set of object classes. In other words, H may be equal to M. In other implementations, source k may only have provided annotations for a subset of the set of object classes, and so H may be less than M. The term

$${α}_{0 m , η}^{( k )}$$

is a parameter of a Dirichlet prior associated with source k, dependent on both the global class m∈{0, . . . , M} and the local classes η∈{0, . . . , H} annotated by source k. The function represented by [symbol] is an indicator function which is equal to 1 if and only if the condition inside the function is true, and is O otherwise. The above equations may be used to minimise a negative evidence lower bound (ELBO), denoted as

$${ℒ}_{i}^{ELBO} = - {\sum }_{m} {q}_{i , m} log {p}_{i , m} .$$

The method 300 determines 309 inferred probabilities for each class m, and an inferred objectness score using the current posterior probabilities q_{i,m}. The inferred probability for class m is denoted as y_{i,m}, and the inferred objectness score is denoted as φᵢ.

In some implementations, this may comprise filtering out any predicted object/bounding box i for which q_{i,0}≥q_{i,m} for all m∈{1, . . . , M}. This condition indicates all predicted objects/bounding boxes for which the posterior probability indicates a higher or equal probability for the background class than any other object class in the set of object classes. In other words, the posterior approximating probability distribution indicates a low probability that any object is present in the area/portion of the image 302 corresponding to index i. The inferred objectness score may be defined as φᵢ=1−q_{i,0}. The inferred probability for class m∈{1, . . . , M} may be defined as y_{i,m}=q_{i,m}. Alternatively, the inferred probability for class m∈{1, . . . , M} may be defined as

$${y}_{i , m} = {q}_{i , m} / {\sum }_{{m}^{′} = 1}^{M} {q}_{i , {m}^{′}} .$$

In implementations where the object detection neural network 304 generates an output representing the probability for a background class included in the set of object classes, e.g. as part of the independently calculated probabilities, and does not generate an objectness score, the inferred probability for class m∈{0, . . . , M} may be defined as y_{i,m}=q_{i,m}. The i^{th} bounding box may be considered labelled by source k if the centre of the location specified in the training label lies within the bounding box.

For example, an inferred location parameter (e.g. absolute co-ordinates, or relative co-ordinates which may be in the form of offset co-ordinates and scale parameters) may be determined as:

$${b}_{i} = \frac{{\sum }_{{k}^{′} = 1}^{K} {b}_{i , {k}^{′}} 𝕀 [ {c}_{i}^{( {k}^{′} )} > 0 ]}{{\sum }_{{k}^{′} = 1}^{K} 𝕀 [ {c}_{i}^{( {k}^{′} )} > 0 ]}$$

In the above equation, b_{i,k}, represents a location parameter (e.g. (e.g. a coordinate, a scale parameter, etc.) for an object/bounding box corresponding to index i provided by source k′ in the training labels 303. The term

$$𝕀 [ {c}_{i}^{( {k}^{′} )} > 0 ]$$

is used to filter out objects/bounding boxes that correspond to the background class, e.g.

$${c}_{i}^{( {k}^{′} )} = 0$$

may represent that the particular object/bounding box belongs to the background class. In some implementations, each location parameter provided by source k′ may be weighted, and a weighted average determined from location parameters provided by all sources for the predicted object/bounding box may be used to determine the inferred location parameter. For example, a weight may be determined for each source k′ based on a hyperparameter of the posterior approximating distribution (e.g. based on a hyperparameter of a source component associated with source k′.

An inferred training label for object/bounding box i is determined using the inferred probabilities and the inferred objectness scores. For example, the inferred training label may comprise an inferred probability distribution over the set of object classes and the inferred objectness score. The inferred probability distribution may be represented as yᵢ, wherein yᵢ is a vector of M elements, with the m^{th} element of the vector given by y_{i,m}. The inferred training label further comprises an inferred location for the predicted object/bounding box corresponding to index i. For example, locations for the predicted object/bounding box corresponding to index i may be averaged over the training labels 303 for the image 302 to determine an inferred location.

After determining the inferred training labels, the object detection neural network 304 is trained using the inferred training labels. This comprises updating parameters of the object detection neural network 304 in dependence on the generated outputs 305 and the inferred training labels. The parameters of the object detection neural network 304 may be updated to optimize an objective function using any suitable optimisation procedure, e.g. gradient-based methods involving backpropagation such as stochastic gradient descent, mini-batch gradient descent, or batch gradient descent, including momentum-based methods such as Adam, RMSProp, and AdaGrad.

The objective function comprises a plurality of loss functions for each predicted object/bounding box generated for each image 302.

The plurality of loss functions comprises one or more classification loss functions, which is computed for each predicted object/bounding box i. The classification loss function is dependent on the inferred probabilities y_{i,m} and the independently calculated probabilities ŷ_{i,m}. For a predicted object/bounding box i assigned to a ground-truth object, a binary cross entropy loss may be computed as a classification loss function for each of the M classes as:

$${ℒ}_{i , m}^{cls} = - {y}_{i , m} log {\hat{y}}_{i , m} - ( 1 - {y}_{i , m} ) log ( 1 - {\hat{y}}_{i , m} )$$

In implementations where the object detection neural network 304 generates an output representing the probability for a background class included in the set of object classes, the classification loss may comprise a multi-class cross entropy loss. For example, a multi-class cross entropy loss may be computed as a classification loss function as:

$${ℒ}_{i}^{cls} = - {\sum }_{m = 0}^{M} {y}_{i , m} log {\hat{y}}_{i , m}$$

The plurality of loss functions further comprises one or more location loss functions, which are computed for each predicted object/bounding box i. For a predicted object/bounding box i assigned to a ground-truth object, a mean-squared error loss may be computed as a location loss function as:

$${ℒ}_{i}^{loc} = \frac{1}{L} {\sum }_{l = 1}^{L} ( {b}_{i , l} - {\hat{b}}_{i , l} )$$

In the above loss function, b_{i,l} represents inferred location parameters (e.g. absolute co-ordinates, or relative co-ordinates which may be in the form of offset co-ordinates and scale parameters), and \hat{b}_{i,l} represents corresponding predicted location parameters.

A location loss function may be based on an Intersection over Union metric. The Intersection over Union metric may compare an overlapping area between a predicted bounding box and a corresponding inferred bounding box to a total area defined by the two boxes. For example, a location loss function may be computed as:

$${ℒ}_{i}^{loc} = 1 - \frac{\vert S ( {\hat{b}}_{i} ) ⋂ S ( {b}_{i} ) \vert}{\vert S ( {\hat{b}}_{i} ) ⋃ S ( {b}_{i} ) \vert}$$

In the above equation, S(\hat{b}ᵢ) and S(bᵢ) define the areas corresponding to a predicted bounding box and an inferred bounding box respectively.

The plurality of loss functions may further comprise an objectness loss function which is computed for each predicted object/bounding box i. The objectness loss function is dependent on the inferred objectness score φᵢ and the predicted objectness score \hat{φ}ᵢ. For a predicted object/bounding box i assigned to a ground-truth object, a binary cross entropy loss may be computed as an objectness loss function as:

$${ℒ}_{i}^{obj} = - {ϕ}_{i} log {\hat{ϕ}}_{i} - ( 1 - {ϕ}_{i} ) log ( 1 - {\hat{ϕ}}_{i} )$$

The above binary cross entropy loss function may be considered to be a soft binary cross entropy loss, as the targets di may be soft targets (e.g. not constrained to either be 0 or 1).

For a particular image 302 of a training example, a training loss function comprises a combination of the one or more classification loss functions, the one or more location loss functions, and optionally, the objectness loss function. The various loss functions may each be averaged over all predicted objects/bounding boxes i for the image 302 to form the training loss function for the training example. An objective function for updating parameters of the object detection neural network 304 may be formed from a combination of the training loss functions of one or more training examples.

After updating parameters of the object detection neural network 304, the process described in FIG. 3 can be repeated for a subsequent training iteration. The training process may be terminated using any suitable termination criteria. For example, the training process may be terminated after performing a certain number of training iterations. As another example, the training process may be terminated based on assessing the performance of the object detection neural network 304 on one or more (unseen) validation examples which were not used to train the object detection neural network 304. For example, if the object detection neural network 304 generates outputs with an accuracy metric over a certain threshold, the training process may be terminated.

FIG. 4 is a flowchart illustrating an example method 400 for training an object detection neural network. FIG. 4 describes a general overview of the methods described in relation to FIG. 3.

In step 4.1, one or more training examples are received. Each training example comprises an image and one or more training labels. Each training label is derived from a respective source from a set of sources. Each training label comprises object information for each of one or more objects in the image. The object information comprises a representation of: (i) a location of the object in the image, and (ii) a class for the object represented by the object information, the class being a class from a set of object classes.

Step 4.2 comprises steps 4.2.1 and 4.2.2 which are both performed for each of the one or more training examples.

In step 4.2.1, an output is generated for the training example. This comprises processing the image of the training example using the object detection neural network. The output comprises predicted object information for each of one or more predicted objects in the image, each predicted object information comprising a representation of: (i) a predicted location of the predicted object in the image, and (ii) a predicted probability distribution over the set of object classes.

Generating an output for the training example may comprises generating, as output of the object detection neural network, a predicted bounding box output for each of one more bounding boxes for the image. The predicted bounding box output may comprise a representation of: (i) a position for the predicted bounding box with respect to the image, (ii) an objectness score representing the probability that any object is present in an area of the image specified by the predicted bounding box, and (iii) a probability, independently calculated for each class in the set of object classes, that an object of the class is present in the area of the image specified by the predicted bounding box.

The predicted probability distribution over the set of object classes for each predicted object may be a predicted probability distribution over the set of object classes for a respective predicted bounding box associated with the predicted object. The predicted probability distribution over the set of object classes for the respective predicted bounding box may be determined using the objectness score for the predicted bounding box and the independently calculated probabilities for the predicted bounding box.

The set of object classes may comprise one or more object classes and a background class. The predicted probability distribution over the set of object classes for the respective bounding box may be determined by determining a predicted probability for the background class. This may comprise subtracting the objectness score from a total probability value (e.g. 1). A predicted probability may be determined for each of the one or more object classes. This may comprise determining a normalisation value, comprising performing a summation of the independently calculated probabilities of the one or more object classes. A normalised probability may be determined for each of the one or more object classes. This may comprise normalising the independently calculated probability for the object class using the normalisation value. Determining the predicted probability for each of the one or more object classes, may comprise weighting the normalised probability for the object class using the objectness score.

In step 4.2.2, a training loss is determined for the training example. This comprises determining an inferred training label for each of one or more predicted objects. The inferred training label comprises a representation of: (i) an inferred location of the predicted object, and (ii) an inferred probability distribution over the set of object classes for the predicted object. The inferred probability distribution is determined based on a posterior approximating distribution over the set of object classes, wherein the posterior approximating distribution is determined using the predicted probability distribution and a Dirichlet distribution as a prior distribution.

The posterior approximating distribution may be determined by determining, from the predicted probability distribution, a predicted class probability for each class in the set of object classes. A weighted predicted class probability may be determined for each predicted class probability. This may comprise weighting the predicted class probability by a respective weight. The weight may be based on the prior distribution, a previous iteration of the posterior approximating distribution, and the respective sources of the one or more training labels. A normalisation value may be determined. This may comprise performing a summation of the weighted predicted class probabilities. The posterior approximating distribution may comprise a posterior probability for each class in the set of object classes. The posterior probability for each class may be determined by normalising the weighted predicted class probability for the class using the normalisation value.

The weight for each predicted class probability may be determined by performing a summation of source components. Each source component is dependent on a respective source of the one or more training labels. The weight for the predicted class probability may be determined by exponentiating (i.e. applying an exponent to) the summation of source components.

Each source component dependent on a respective source of the one or more training labels may be determined by obtaining the previous iteration of the posterior approximating distribution for one or more previous training examples of a previous training iteration. Each of the previous training examples may be labelled by the same source of the training example of the current training iteration as having the same class as the training example of the current training iteration. For each class in the set of object classes, a summation of previous posterior probabilities for the class may be performed. Each previous posterior probability may be obtained from a respective posterior approximating distribution for the one or more previous training examples. For each class in the set of object classes, the summation of previous posterior probabilities for the class may be combined with a Dirichlet prior distribution parameter that is dependent on the source, the class in the set of object classes, and the class of the training label. The source component may be determined using the summation of previous posterior probabilities for the class with the Dirichlet prior distribution parameter.

The set of object classes may comprise one or more object classes and a background class. The posterior approximating distribution over the set of object classes may comprise a posterior probability for each object class and a posterior probability for the background class. Determining, for each of the one or more predicted objects, the inferred training label may comprise determining that the posterior probability for at least one of the one or more object classes is greater than the predicted probability for the background class. The inferred probability distribution for the predicted object may be determined wherein the inferred probability distribution comprises an inferred probability for each object class that is determined using the posterior probability for the object class.

A classification loss and a location loss are determined for each of the one or more predicted objects. The classification loss is determined in dependence on the predicted probability distribution and the inferred probability distribution for the predicted object. The location loss is determined in dependence on the predicted location and the inferred location of the predicted object.

The training loss is determined for the training example. The training loss comprises a combination of the one or more classification losses and the one or more location losses.

The training loss for each training example may further comprise an objectness loss for each of the one or more predicted objects. The objectness loss may be dependent on a predicted objectness score and an inferred objectness score for the predicted object. The inferred objectness score for the predicted object may be determined from the posterior approximating distribution.

In step 4.3, parameters of the object detection neural network are updated based on the training loss of one more training examples.

Each of the images of the training examples may be a dental radiograph (e.g. a bitewing radiograph), and the set of object classes may comprise a plurality of dental diseases. The dental diseases may include bone loss and dental caries.

The method 400 may further comprise performing a plurality of training iterations to obtain a trained object detection neural network. One or more images may be received; and object detection may be performed using the trained object detection neural network. This comprises processing the one or more images using the trained object detection neural network.

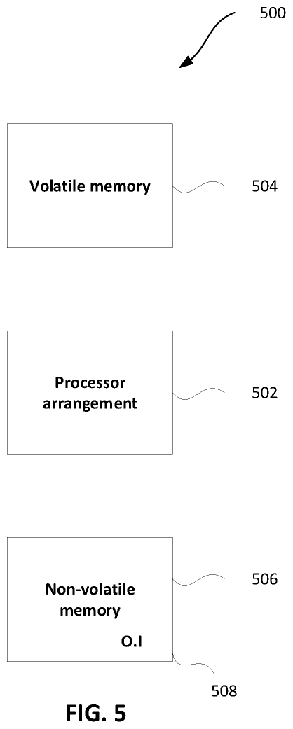

FIG. 5 shows a schematic example of a system/apparatus 500 for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 500 comprises one or more processors 502. The one or more processors control operation of other components of the system/apparatus 500. The one or more processors 502 may, for example, comprise a general purpose processor. The one or more processors 502 may be a single core device or a multiple core device. The one or more processors 502 may comprise a central processing unit (CPU) or a graphical processing unit (GPU). Alternatively, the one or more processors 502 may comprise specialised processing hardware, for instance a RISC processor or programmable hardware with embedded firmware. Multiple processors may be included.

The system/apparatus comprises a working or volatile memory 504. The one or more processors may access the volatile memory 504 in order to process data and may control the storage of data in memory. The volatile memory 504 may comprise RAM of any type, for example Static RAM (SRAM), Dynamic RAM (DRAM), or it may comprise Flash memory, such as an SD-Card.

The system/apparatus comprises a non-volatile memory 506. The non-volatile memory 506 stores a set of operation instructions 508 for controlling the operation of the processors 502 in the form of computer readable instructions. The non-volatile memory 506 may be a memory of any kind such as a Read Only Memory (ROM), a Flash memory or a magnetic drive memory.

The one or more processors 502 are configured to execute operating instructions 508 to cause the system/apparatus to perform any of the methods described herein. The operating instructions 508 may comprise code (i.e. drivers) relating to the hardware components of the system/apparatus 500, as well as code relating to the basic operation of the system/apparatus 500. Generally speaking, the one or more processors 502 execute one or more instructions of the operating instructions 508, which are stored permanently or semi-permanently in the non-volatile memory 506, using the volatile memory 504 to temporarily store data generated during execution of said operating instructions 508.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 5, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims.

1. A method implemented by one or more processors for training an object detection neural network comprising a plurality of parameters, the method comprising:
receiving one or more training examples of a current training iteration, each training example comprising an image and one or more training labels, each training label derived from a respective source from a set of sources, wherein each training label comprises object information for each of one or more objects in the image, the object information comprising a representation of: (i) a location of the object in the image, and (ii) a class for the object represented by the object information, the class being a class from a set of object classes;
for each of the one or more training examples for the current training iteration:
generating an output for the training example, comprising processing the image of the training example using the object detection neural network, wherein the output comprises predicted object information for each of one or more predicted objects in the image, each predicted object information comprising a representation of: (i) a predicted location of the predicted object in the image, and (ii) a predicted probability distribution over the set of object classes; and
determining a training loss for the training example, comprising:
determining, for each of the one or more predicted objects, an inferred training label comprising a representation of: (i) an inferred location of the predicted object, and (ii) an inferred probability distribution over the set of object classes for the predicted object, the inferred probability distribution being determined based on a posterior approximating distribution over the set of object classes, wherein the posterior approximating distribution is determined using the predicted probability distribution and a Dirichlet distribution as a prior distribution;
determining, for each of the one or more predicted objects, a classification loss in dependence on the predicted probability distribution and the inferred probability distribution for the predicted object, and a location loss in dependence on the predicted location and the inferred location of the predicted object; and
determining the training loss for the training example, the training loss comprising a combination of the one or more classification losses and the one or more location losses; and
updating the parameters of the object detection neural network based on the training loss of one or more training examples.

2. The method of claim 1, wherein generating an output for the training example comprises generating, as output of the object detection neural network, a predicted bounding box output for each of one more bounding boxes for the image, the predicted bounding box output comprising a representation of: (i) a position for the predicted bounding box with respect to the image, (ii) an objectness score representing the probability that any object is present in an area of the image specified by the predicted bounding box, and (iii) a probability, independently calculated for each class in the set of object classes, that an object of the class is present in the area of the image specified by the predicted bounding box.

3. The method of claim 2, wherein the predicted probability distribution over the set of object classes for each predicted object is a predicted probability distribution over the set of object classes for a respective predicted bounding box associated with the predicted object.

4. The method of claim 3, wherein the predicted probability distribution over the set of object classes for the respective predicted bounding box is determined using the objectness score for the predicted bounding box and the independently calculated probabilities for the predicted bounding box.

5. The method of claim 4, wherein the set of object classes comprises one or more object classes and a background class, and wherein the predicted probability distribution over the set of object classes for the respective bounding box is determined by:
determining a predicted probability for the background class, comprising subtracting the objectness score from a total probability value; and
determining a predicted probability for each of the one or more object classes, comprising:
determining a normalisation value, comprising performing a summation of the independently calculated probabilities of the one or more object classes;
determining a normalised probability for each of the one or more object classes, comprising normalising the independently calculated probability for the object class using the normalisation value; and
determining the predicted probability for each of the one or more object classes, comprising weighting the normalised probability for the object class using the objectness score.

6. The method of any preceding claim, wherein the posterior approximating distribution is determined by:
determining, from the predicted probability distribution, a predicted class probability for each class in the set of object classes;
determining a weighted predicted class probability for each predicted class probability, comprising weighting the predicted class probability by a respective weight, wherein the weight is based on the prior distribution, a previous iteration of the posterior approximating distribution, and the respective sources of the one or more training labels;
determining a normalisation value, comprising performing a summation of the weighted predicted class probabilities; and
determining the posterior approximating distribution, wherein the posterior approximating distribution comprises a posterior probability for each class in the set of object classes, the posterior probability for each class being determined by normalising the weighted predicted class probability for the class using the normalisation value.

7. The method of claim 6, wherein the weight for each predicted class probability is determined by:
performing a summation of source components, each source component dependent on a respective source of the one or more training labels; and
determining the weight for the predicted class probability by exponentiating the summation of source components.

8. The method of claim 7, wherein each source component dependent on a respective source of the one or more training labels is determined by:
obtaining the previous iteration of the posterior approximating distribution for one or more previous training examples of a previous training iteration, wherein each of the previous training examples are labelled by the same source of the training example of the current training iteration as having the same class as the training example of the current training iteration;
for each class in the set of object classes, performing a summation of previous posterior probabilities for the class, each previous posterior probability being obtained from a respective posterior approximating distribution for the one or more previous training examples;
for each class in the set of object classes, combining the summation of previous posterior probabilities for the class with a Dirichlet prior distribution parameter that is dependent on the source, the class in the set of object classes, and the class of the training label; and
determining the source component using the summation of previous posterior probabilities for the class with the Dirichlet prior distribution parameter.

9. The method of any preceding claim, wherein the set of object classes comprises one or more object classes and a background class, the posterior approximating distribution over the set of object classes comprises a posterior probability for each object class and a posterior probability for the background class, and determining, for each of the one or more predicted objects, the inferred training label comprises:
determining that the posterior probability for at least one of the one or more object classes is greater than the predicted probability for the background class; and
determining the inferred probability distribution for the predicted object, wherein the inferred probability distribution comprises an inferred probability for each object class that is determined using the posterior probability for the object class.

10. The method of any preceding claim, wherein the training loss for each training example further comprises an objectness loss for each of the one or more predicted objects, the objectness loss dependent on a predicted objectness score and an inferred objectness score for the predicted object.

11. The method of claim 10, wherein the inferred objectness score for the predicted object is determined from the posterior approximating distribution.

12. The method of any preceding claim, wherein each of the images of the training examples is a dental radiograph, and the set of object classes comprise a plurality of dental diseases, the dental diseases including bone loss and dental caries.

13. The method of any preceding claim, further comprising:
performing a plurality of training iterations to obtain a trained object detection neural network;
receiving one or more images; and
performing object detection using the trained object detection neural network, comprising processing the one or more images using the trained object detection neural network.

14. A computing system configured to perform the method of any preceding claim.

15. A non-transitory computer-readable containing instructions, which when executed by one or more processors, cause the processor to perform the method of any one of claims 1-13.
